(19) United States
(12) Patent Application Publication
(10) Pub. No.: US 2015/0191259 A1
(43) Pub. Date: Jul. 9, 2015

(54) DEVICE AND METHOD FOR AUTOMATICALLY CONTROLLING A WINCH DEVICE AND VEHICLE EQUIPPED WITH SAID DEVICE

(71) Applicant: OTO Melara S.p.A., La Spezia (IT)

(72) Inventors: Andrea Giovannini, La Spezia (IT); Fabio Varone, La Spezia (IT)

(21) Appl. No.: 14/390,677

(22) PCT Filed: Apr. 2, 2013
(86) PCT No.: PCT/IB2013/052618

§ 371 Date: Oct. 3, 2014

(30) Foreign Application Priority Data
Apr. 5, 2012 (IT) TO2012A000299

(51) Int. Cl. B64F 3/00; B64C 39/02; B66D 1/48

(52) U.S. Cl. CPC B64F 3/00; B66D 1/485; B64C 39/022; B64C 39/024; B64C 2201/148; B64C 2201/123

(57) ABSTRACT

A method automatically controls the movement of a winch device (2), which is adapted to pull in or let out a cable (T), to which at least one flying device 4 is connected. The method includes the following subsequent steps: a) determining the relative position between the winch device (2) and the flying device (4); b) calculating the optimal length of the cable “T” as a function of the relative distance determined during the previous step; c) activating said winch device (2), so as to obtain the desired length of the cable “T” calculated during the previous step; d) repeating the sequence of steps a)-c) for a desired amount of time; in order to obtain, in real time, the optimal length of the cable (T) as a function of the changes in the relative position between the winch device (2) and the flying device (4).

The present invention relates to a device and to a method for automatically controlling a winch device and, in particular, its movement, said winch device being applied to a vehicle comprising a flying surveillance and patrol device, which is connected to said vehicle by means of a cable.

The relative positioning between the surveillance device and the vehicle is controlled by said control device, adapted to activate and deactivate a winch device, and by the method associated therewith.

Flying surveillance devices are known, which are connected to a fixed or mobile unit and are adapted to reach a given height with respect to the fixed or mobile unit, so as to constantly monitor a predetermined area, such as a border area, both on the ground and at sea.

These surveillance devices are provided with propulsion devices, adapted to keep said devices at a given height. Said propulsion devices are electrically operated and are, for example, electric motors. Normally, power is supplied to said motors by means of said cable, which comprises at least one power supply line.

Said surveillance devices are used in places where surveillance has to be constant and, therefore, said devices have to remain at a given height on a constant basis. It is only at the end of a mission that said devices are recovered by means of a common winch, which is manually or automatically operated.

Said surveillance devices, furthermore, are used in places where there are no obstacles to their movement. In particular, the mobile units, to which said surveillance devices are connected, are adapted to move along paths where there are no obstacles that could hinder the movement of the surveillance devices or of the cable, which is adapted to connect the surveillance device to the mobile unit.

Finally, said devices are adapted to always remain at the maximum height defined by the length of the cable and, as mentioned above, are brought back to the ground when their mission is over or when repairs have to be performed.

In case there was an obstacle that could hit the cable or the surveillance device, there would be no way to avoid the impact, since the winch that pulls in or lets out the cable is not adapted to follow the movements of the surveillance device, thus creating damages to the surveillance device itself. Furthermore, in case the relative height or position between the surveillance device and the mobile unit changes, the winch is not able to follow the movements of the surveillance device. As a matter of fact, if the surveillance device would lose height, the cable would become too loose, thus increasing the chances for the cable itself to get stuck in other objects or in the mobile unit itself, since the winch is not able to autonomously activate itself in order to pull in the excess cable. On the other hand, if the surveillance device tried to increase its flying height, it would be hindered, since the winch is not able to provide it, in a reasonable time, with the amount of cable that it needs to reach the desired height.

The object of the present invention is to solve the problems mentioned above by providing a device and a relative method for controlling a winch device, which is able to follow, in real time, the Movements of a flying surveillance device, which is connected to said winch by means of a cable, by determining the optimal length of the cable itself and by activating said winch so as to obtain the optimal and/or desired length of the cable.

An aspect of the present invention is relative to a method for controlling a winch according to claim 1.

A further aspect of the present invention is relative to a device for controlling a winch according to claim 6. Finally, a further aspect of the present invention is relative to a vehicle comprising a winch controlling device according to claim 15.

Further accessory features are set forth in the appended dependent claims.

The features and advantages of the present invention will be best understood upon perusal of the following description of at least one preferred embodiment with reference to the accompanying drawings, which respectively illustrate what follows:

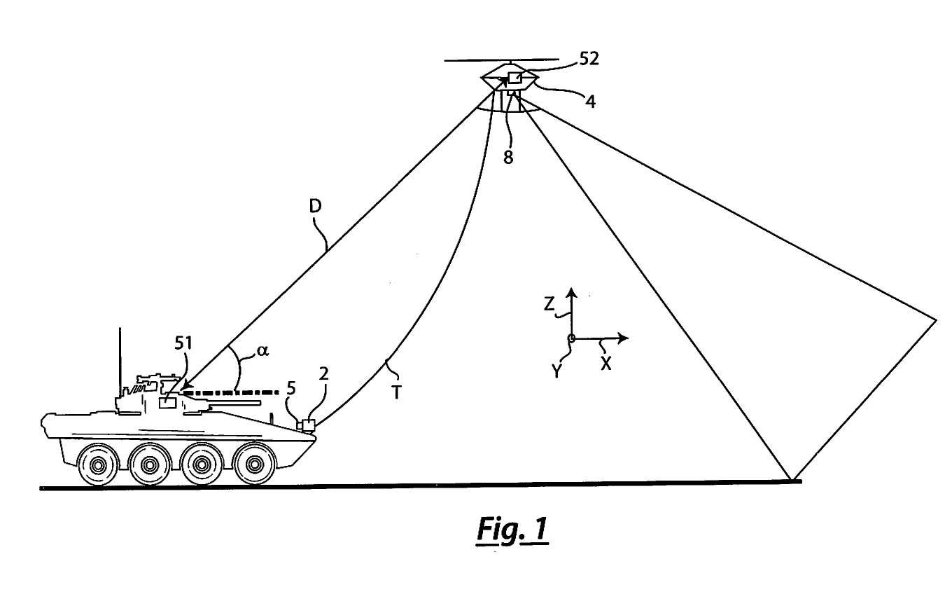

FIG. 1 shows an application of the control device according to the present invention on a vehicle;

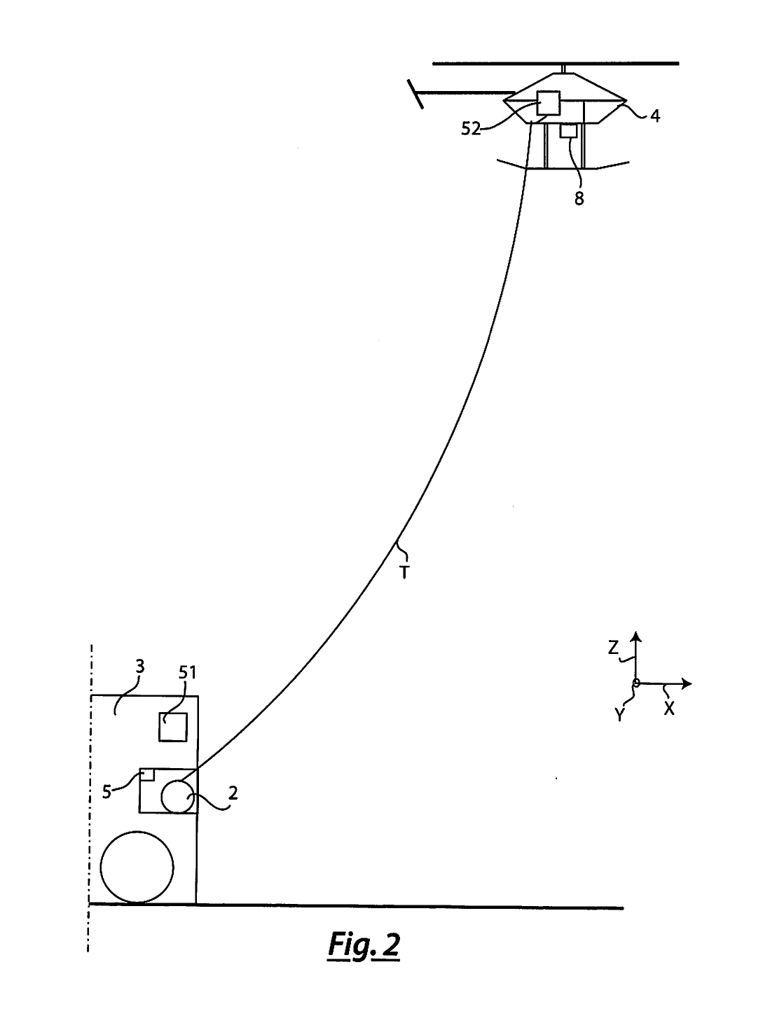

FIG. 2 shows a flying device and a base unit comprising a winch device controlled by the control device according to the present invention;

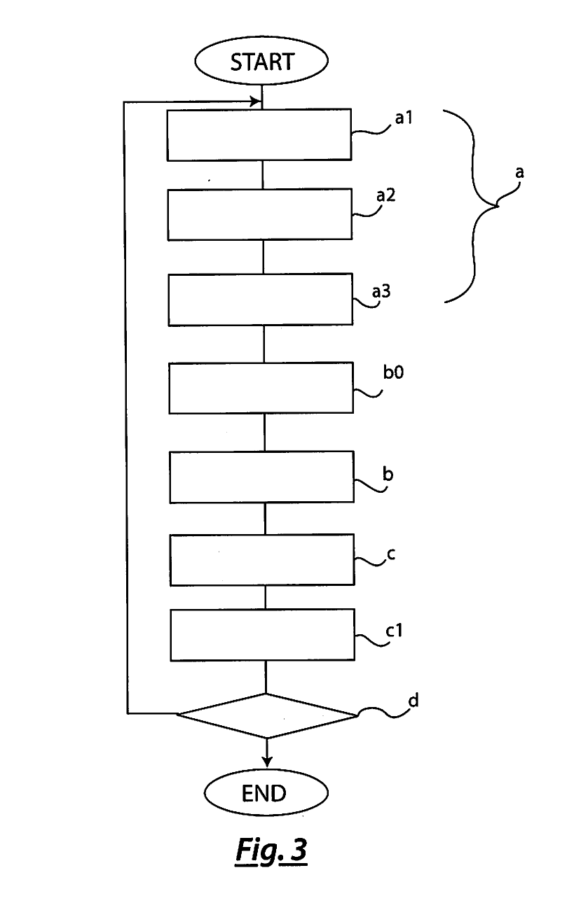

FIG. 3 shows a flowchart of the control method according to the present invention;

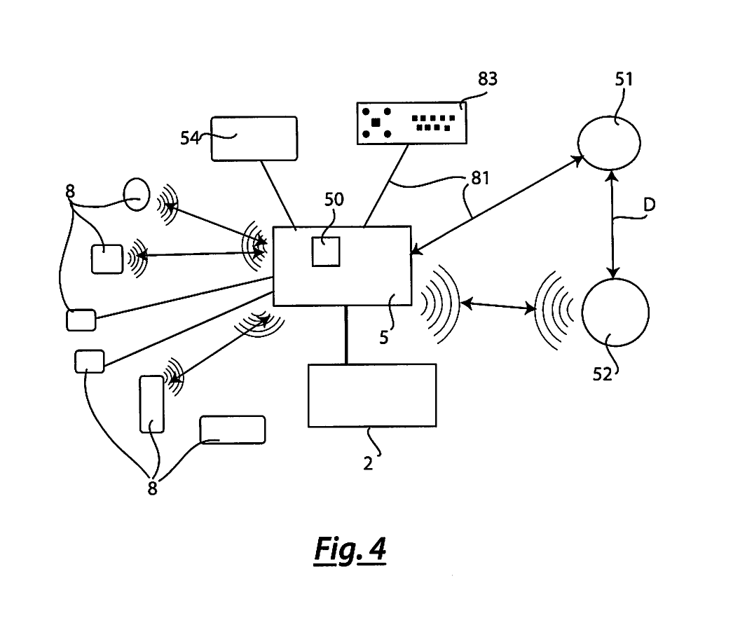

FIG. 4 shows a block diagram of the control device according to the present invention.

With reference to the figures mentioned above, the method for automatically controlling the movement of a winch device 2, adapted to pull in or let out a cable “T”, to which at least one flying device 4 is connected, comprises the following subsequent steps:
a) determining the relative position between said winch device 2 and flying device 4;
b) calculating the optimal length of cable “T” as a function of the relative position determined during the previous step;
c) activating said winch device 2, so as to obtain the desired length of cable “T” calculated during the previous step;
d) repeating the sequence of steps a)÷c) for a desired period, in order to obtain, in real time, the optimal length of cable “T” as a function of the changes in the relative position between the winch device 2 and flying device 4.

The preferred sequence of the steps of the method according to the present invention is shown in a flowchart illustrated in FIG. 3.

Control device 5 associated with said method is adapted to control a which device 2 applied to a base unit 3.

Winch device 2, therefore, is adapted to pull in or let out a cable “T”, which connects at least one flying device 4 to said base unit 3, as shown, by way of example, in FIG. 2. Said flying device 4 comprises at least one propulsion device, not shown, which is adapted to allow flying device 4 itself to move, for example in “XYZ” space.

Said propulsion device is, for example, at least one propeller flush fitted to the rotor of at least one motor, preferably an electric motor. The motor of said propulsion device can be supplied with power by means of a battery arranged on the inside of flying device 4, or it can be supplied with power by means of a power supply line, for example arranged inside said cable “T”.

Preferably, said electric motor is supplied with a voltage of 400÷600 V, for example with a direct current. Said flying device 4 is compliant with the standards for managing and designing vehicles without pilot, also known as “UAV” o “UAS”.

The movements of said flying device 4 are activated only by means of said propulsion device and can be performed irrespective of cable “T” pulled in or let out by winch device 2.

Said cable “T” is preferably made of a metal material, for example mesh, with predetermined breaking loads, which is able to flex and resist possible unintentional obstacles. The size of said cable “T” preferably is of 6÷8 mm of diameter, with a length, for example, of 100 m.

Winch device 2 preferably is a winch or a hoist comprising an electric motor, which is also supplied with a voltage of 400÷600 V in direct current.

Preferably, according to the method of the present invention, the step a) of determining the relative position comprises a first sub-step a1) of determining the spatial position of said winch device 2; a second sub-step a2) of determining the spatial position of flying device 4; and a further sub-step a3) of calculating the relative position between flying device 4 and winch device 2. The order in which steps a1) and a2) are performed can be reversed and the result of the calculation performed in step a3) does not change.

In order to determine the spatial position of winch device 2, according to step a1), base unit 3 comprises a first spatial locating system 51, for example a GPS system, adapted to determine, with an uncertainty lower than one meter, the spatial position in space “XYZ” defined by the three Cartesian axes (X, Y, Z).

Furthermore, in order to determine the spatial position of flying device 4, according to step a2), said at least one flying device 4 comprises a second spatial locating system 52, for example a GPS system, adapted to determine, with an uncertainty lower than one meter, the spatial position in space “XYZ” defined by the three Cartesian axes (X, Y, Z).

Control device 5 comprises a data processing unit 50, adapted to determine the relative position between said at least one flying device 4 and said base unit 3 as a function of the data obtained from said first and second spatial locating systems (51, 52). Determining the relative position between said at least one flying device 4 and said base unit 3 leads to controlling, in real time, the movement of said winch device 2, in order to obtain the optimal length of cable “T” as a function of the changes in the relative position. The changes in the relative distance between said at least one flying device 4 and said base unit 3 are in real time.

For the purposes of the present invention, the term “real time” means that the operations aimed at calculating the relative position are performed on a constant basis, at predetermined time intervals, as a function of the speed at which the method according to the present invention is carried out.

Said data processing unit 50 is, by way of example, a microprocessor, adapted to process the data coming from the first and second spatial locating systems (51, 52), thus calculating the relative position between flying device 4 and base unit 3.

The calculation of the relative position between flying device 4 and base unit 3, besides determining linear distance “D”, allows the user to obtain a plurality of additional items of information, such as, for example, elevation angle “a” and the azimuthal angle between flying device 4 and base unit 3. These data, i.e. linear distance “D”, elevation angle “a” and azimuthal angle, allows the user to unequivocally determine, for example in polar coordinates, the position of flying device 4 with respect to the reference position of base unit 3.

Said data processing unit 50, furthermore, is able to perform the step b) of calculating the optimal length of cable “T”. Indeed, by means of a predetermined calculus, for example a recursive algorithm, the user can calculate the optimal tension of cable “T” and, as a consequence, determine the optimal length as a function of the results obtained in the step a3) of calculating the relative position.

Preferably, said algorithm can be stored in a non-volatile memory medium (54), aapted to be connected to said data processing unit 50, as shown by way of example in FIG. 4. For the purposes of the present invention, the term 30. “optimal length” indicates a length of cable “T” that allows flying device 4 to perform a predetermined movement, such as, for example, increasing the flying height by a value lower than one meter.

The term “optimal tension” of cable “T” indicates a tension of cable “T” that avoids the formation of loops in the cable itself, which might get stuck in objects arranged between base unit 3 and flying device 4. The tension of cable “T” and, therefore, its length, in any case, are such as to allow flying device 4 to be able to perform movements without cable “T” reaching a tension state before control device 5 has activated winch device 2 to let out cable “T”.

The method according to the present invention comprises, prior to the step b) of calculating the optimal length of cable “T”, a further step b0) of acquiring environmental parameters, which are useful to calculate the optimal length of cable “T”. These parameters are, for example, wind, humidity, etc. or presence of obstacles close to the flying device and/or to cable “T” and/or to base unit 3. Said environmental parameters can also include the morphology of the ground close to unit 3.

In order to acquire said environmental parameters, control device 5 and, in particular, data processing unit 51 are adapted to be connected to a plurality of sensors 8, which are adapted to acquire environmental parameters, such as temperature, humidity and wind force, which are useful for the calculation of the optimal length of cable “T”.

Control device 5 is adapted to be connected to sensors, which are able to detect the presence of obstacles and objects, such as sonars, radars, infrared sensors and visual sensors such as video cameras.

Said flying device 4 comprises a plurality of said sensors 8, which, besides acquiring environmental parameters, are able to provide images of places that cannot be directly seen from the ground, where said base unit 3 is normally positioned, so as to perform surveillance or patrol tasks in sensitive areas. By means of said plurality of sensors 8, which are located on said flying device 4, it is possible to patrol sensitive areas without the need for the vehicles or the people to be directly close to said areas to be subject to surveillance and patrol operations.

For the purposes of the present invention, the term “sensitive areas” indicates those places where moving around is difficult due to both natural and geopolitical reasons, such as battle fields and border areas.

Said flying device 4, therefore, allows users to widen their visual field without the need to directly expose people or vehicles.

Said plurality of sensors 8 are preferably adapted to monitor predetermined portions of space, which are identified, for example, by an imaginary cone or visual cone.

Said algorithm preferably is recursive, for example an algorithm able to follow the movements of flying device 4 in real time.

According to the method of the present invention, the step c) of activating said winch device 2 comprises a step c1) of accelerating and decelerating the rotation speed of said winch 2 according to a predetermined development in time. Preferably, as a function of the acceleration with which said flying device 4 moves with respect to unit 3, the control device, thanks to data processing unit 50 and to the calculation algorithm, is able to send an activation signal to said winch device 2, which also specifies the acceleration with which said winch device 2 has to rotate in order to let out or pull in cable “T”.

The acceleration with which flying device 4 moves with respect to unit 3, and vice versa, is determined as a function of the data obtained from said first and second spatial locating systems (51, 52).

Preferably, since winch device 2 has to follow the movements of said flying device 4, the acceleration with which said winch device 2 has to rotate to pull in or let out cable “T” is directly proportional to the acceleration with which flying device 4 moves.

Furthermore, in case the acceleration is equal to zero, i.e. the movement of flying device 4 has a constant speed, the rotation of winch device 2 to pull in or let out cable “T” has an acceleration/deceleration that is such as to cause the length of cable “T” to always be the optimal length. In order to determine the rotation speed and the acceleration/deceleration, one also has to take into account the quantity of cable “T” already wound in winch device 2, so as to cause cable “T” to be pulled in or let out so as to always guarantee the optimal length of cable “T” between winch device 2 and flying device 4. Indeed, as a skilled already knows, the rotation speed of winch device 2 varies as a function of the length of cable wound in winch device 2 itself.

Control device 5, thanks to said data processing unit 50, is able to generate a control signal for the winch device 2, which is such as to obtain a rotation speed and/or an acceleration/deceleration of the rotation speed according to a predetermined function, so as to follow, in real time, the relative movements between flying device 4 and unit 3.

Said control signal is generated by said control device 5 as a function of a plurality of parameters, which are obtained from said plurality of sensors 8 and from the data obtained after step b).

Said function is determined in such a way that the length of cable “T” between winch device 2 and flying device 4 always is the optimal length.

Said control device 5, in a first preferred embodiment, can be applied to any winch device 2.

In an alternative preferred embodiment, control device 5 is an integral part of winch device 2, said winch comprising said control device 5.

In a further embodiment, control device 5 according to the present invention is preferably applied to a vehicle 30, which is considered as he above-mentioned base unit 3.

As shown in FIG. 1, said vehicle 30 comprises a winch device 2, adapted to pull in or let out a cable “T”, which connects at least one flying device 4 to vehicle 30 itself. In this embodiment, the vehicle is tracked and/or provided with wheels.

Said vehicle 30 can also be a watercraft, for example a boat. Said vehicle 30 can be robotized or provided with a pilot.

Said cable “T”, in the present embodiment, comprises at least on data communication line 81 between said flying device 4 and said control device 5, which, by way of example, is arranged in said vehicle 30.

Both the data coming from said plurality of sensors 8 and the commands for the movements of flying device 4 are transferred by means of said data communication line 81.

Preferably, flying device 4 is remotely controlled by a console or joystick 83, which, by way of example, is arranged in said vehicle 30.

The control signals from said console or joystick 83 are sent by means of said data line 81.

Said plurality of sensors 8 are able to provide images of places outside of the visual field of vehicle 30, i.e. not directly visible.

In the preferred embodiment, said flying device 4 preferably is a small-dimension helicopter, which can move along any desired direction, can rotate on itself and can stand still, floating, for a desired amount of time, so as to easily avoid obstacles along its path. The dimensions of this flying device are small, both to reduce manufacturing costs and to reduce the risk of being identified by third parties; hence, such flying devices are also particularly silent.

Said flying device 4 is moved by means of said console or joystick 83, which can be portable or can be arranged on said vehicle 30. Said console or joystick 83 is able to communicate with said flying device 4 in wireless mode or through a cable connection. Preferably, said console or joystick 83 is arranged in vehicle 30 and communicates with said flying device 4 through said data line 81, which is comprised in cable “T”.

The device and the method for controlling a winch device 2 according to the present invention allow said flying device to be freely moved in order to perform surveillance and/or patrol tasks in areas where there are many obstacle; indeed, as a function of the data obtained from said plurality of sensors 8 and of the relative position between flying device 3 and base unit 3 or vehicle 30, the length of cable “T” is such as to reduce the chances of cable “T” getting stuck in objects or obstacles available close to the two devices (3, 4).

Furthermore, tanks to the fact that flying device 4 is supplied with power by means of a power supply line comprised in said cable “T”, the duration of the patrol operations can be much longer than the one of the patrol operations performed with patrol devices having an autonomous propulsion system; furthermore, thanks to control device 5 according to the present invention and to the method associated thereto, the movements carried out to perform the surveillance and patrol operations are very dynamic, which guarantees self-sufficient surveillance devices.

One single cable “T” allows many different tasks to be fulfilled, namely transmitting the energy necessary to move flying device 4 to the propulsion device, receiving data from said plurality of sensors 8, receiving data from said spatial locating systems (51, 52), by means of said data line 81, and, if necessary, transmitting commands for the movement of flying device 4 generated by said console or joystick 83. In alternative embodiments, like for example the one shown in FIG. 4, part of the data transfer can be performed in wireless mode.

This solution allows users to perform patrol and surveillance tasks in special areas, with the possibility to dynamically move, in real time, flying device 4 for a desired amount of time. Furthermore, when applying control device 5 according to the present invention on a vehicle 30, users can further improve the patrol and/or surveillance abilities of flying device 4, since they can position vehicle 30 in the desired position, which may change in time.

### NUMERICAL REFERENCES

Winch device 2
Base unit 3
Vehicle 30
Flying device 4
Control device 5
Data processing unit 50
First spatial locating system 51
Second spatial locating system 52
Non-volatile memory medium 54
Sensors 8
Data communication line 81
Console or joystick 83
Cable “T”

1. A method for automatically controlling movement of a winch device, for pulling in or letting out a cable, to which at least one flying device is connected, said method comprising the following subsequent steps:
a) determining a relative position between the winch device and the flying device;
b) calculating an optimal length of the cable as a function of the relative position determined during the previous step;
c) activating said winch device, so as to obtain the desired length of the cable calculated during the previous step;
d) repeating the sequence of steps a) through c) for a desired amount of time;
to obtain, in real time, the optimal length of the cable as a function of the changes in the relative position between the winch device and the flying device.

2. The method according to claim 1, wherein the step a) of determining the relative position comprises the following sub-steps:
a1) determining the spatial position of said winch device;
a2) determining the spatial position of the flying device;
a3) calculating the relative position between the flying device and the winch device.

3. The method according to claim 1, wherein the step b) of calculating the optimal length of the cable (T) is carried out by a recursive algorithm.

4. The method according to claim 1, wherein a further step b0) for acquiring environmental parameters, which are useful to calculate the optimal length of the cable, is provided prior to the step b) for calculating the optimal length of the cable.

5. The method according to claim 1, wherein the step c) of activating said winch device comprises a step c1) for accelerating and decelerating a rotation speed of said winch according to a predetermined development in time.

6. A control device for a winch device applied to a base unit;
said winch device is adapted to pull in or let out a cable, which connects at least one flying device to said base unit;
provided with a first spatial locating system;
said at least one flying device is provided with a second spatial locating system;
said control device comprises:
a data processing unit, for determining a relative position between said at least one flying device and said base unit as a function of the data obtained from said first and second spatial locating systems, so as to control movement of said winch device, in order to obtain, in real time, an optimal length of the cable as a function of changes in the relative position.

7. The device according to claim 6, wherein said first spatial locating system is a GPS system, for determining the spatial position, with an uncertainty lower than one meter, in space defined by the three Cartesian axes.

8. Device according to claim 6, wherein said second spatial locating system is a GPS system, for determining the spatial position, with an uncertainty lower than one meter, in space defined by the three Cartesian axes.

9. The device according to claim 6, wherein said control device comprises a non-volatile memory medium connected to said data processing unit, on which a recursive algorithm is stored, for calculating optimal tension of the cable and, as a consequence, to determine the optimal length of the cable.

10. The device according to claim 6, wherein said control device is adapted to be connected to a plurality of sensors, for acquiring environmental parameters, which are useful to calculate the optimal length of the cable.

11. The device according to claim 6, wherein the control device, as a function of the signals received from said data processing unit and as a function of a plurality of parameters, generates a control signal for the winch device to obtain an acceleration or deceleration of a rotation speed of said winch device according to a predetermined function.

12. A vehicle comprising a winch device, for pulling in or letting out a cable, which connects at least one flying device to said vehicle; wherein the vehicle comprises a control device according to claim 1.

13. The vehicle according to claim 12, wherein said at least one flying device comprises at least one propelling member.

14. The vehicle according to claim 12, wherein said cable comprises at least one data communication line communicating data between said flying device and said control device.

15. The vehicle according to claim 12, wherein said flying device is remotely controlled by a console or joystick arranged in said vehicle.

16. The vehicle according to claim 12, wherein said flying device comprises a plurality of sensors, for both acquiring environmental parameters and providing images of places that cannot directly be seen from the vehicle.
